(19) United States
(12) Patent Application Publication
(10) Pub. No.: US 2006/0044368 A1
(43) Pub. Date: Mar. 2, 2006

(54) Bulk-capacity continuous feed printer ink container pack

(76) Inventor: Kuo-Hau Kao, Tu-Cheng City (TW)

Correspondence Address: SUPREME PATENT SERVICES, P.O. BOX 2339, SARATOGA, CA, 95070-0339, US

(21) Appl. No.: 10/931,613

(22) Filed: Aug. 31, 2004

(51) Int. Cl. B41J 2/175

(52) U.S. Cl. 347/85

(57) ABSTRACT

A bulk-capacity continuous feed printer ink container pack includes corresponding number of ink containers and ink supply lines. One end of each ink supply line is connected to output hole of the ink container, and the other end is connected to a refillable ink cartridge of a printer. The structure of the ink container having a rectangular block shape includes a raised block being formed on one sectional surface, and a depressed slot on the opposite sectional surface, both of which are to lock against each other when two or more ink containers are assembled. This ink container pack is able to provide continuous supply of printer ink without interruption of the printer service, and allows general users to refill or replace the printer ink easily without messing up their clothes or documents, that means costs of maintaining the printer ink supply can be considerably decreased.

### BACKGROUND OF THE INVENTION

1. Field of the Invention

The present invention relates to a bulk-capacity continuous feed printer ink container pack, and in particular to a container feed printer ink system that is able to provide continuous ink supply to a printer using multiple bulk-capacity ink containers simultaneously connected to the printer head, and each ink container is also an unitary section that can be assembled in a row with two or more ink containers to form an expandable printer ink container pack to suit the requirements of the printer user.

2. The Related Art

At present, the majority of printer manufacturers have the ink reservoir designed as a disposable ink cartridge for easy replacement by general users, which is classified as an ink supply consumable. As ink jet printers are widely used for producing hard copies of tables, diagrams, and data documents, the demands for these consumables are steadily increasing, but the costs are quite expensive.

Also, the task of replacing or refilling the printer ink cartridge is not that easy for average computer users, who often have ink stains on their hands and all over their clothes in the process of doing so, and the ink materials can also cause pollution to the surrounding environment.

In consideration of the high cost and the pollution issues, ink refilling tool kits are available in the market for general users to refill the ink cartridge when the printer ink runs low or is depleted. The tool kit includes several items, such as siphons and injection needles, for refilling the ink cartridge. The ink cartridge can be reused after replenishing the ink cartridge with ink by the tool kit. However, the refilling has to be performed by the printer user manually, who has to be constantly monitoring the ink level in the ink cartridge if an interruption of printer service is to be avoided.

To prevent any possible interruption of printer service, a bottle feed printer ink system is available, which employs corresponding number of ink supply lines and conventional ink bottles, where each ink supply line is connected between the ink cartridge and a conventional ink bottle, so that a continuous supply of printer ink is fed to the printer without interruption of the printer service.

Since a conventional ink bottle 11, as shown in FIG. 1 of the attached drawings, is directly connected to an ink supply line 12, a color ink jet printer usually has at least four bottles of different color inks, such as black, blue, red, and amber. If more colors are needed, there may be even more ink bottles of assorted colors. These conventional ink bottles 11 are usually grouped together using an organizer box 13 to form a conventional ink bottle assembly 11. This also prevents spilling of the ink from the ink bottles (not shown in the drawings), if the ink bottles are knocked over and the ink supply line 12 are pulled by the ink cartridge that travels along with the printer head in a printing operation, therefore the ink bottles 11 have to be kept at a safe distance. Also, the conventional ink bottle 11 forms only one refill hole in the top, it is necessary to stop the ink flow in the ink supply line 12 during refilling by a line clipper (not shown in the diagram), and then to open up the refill hole 110 of the ink bottle 11 for refilling. This is not a simple job for an average user, as ink stains often messed up the user's hands and clothes in the refilling process.

### SUMMARY OF THE INVENTION

The primary objective of the present invention is to provide a bulk-capacity continuous feed printer ink container pack that can provide continuous supply of printer ink obviating the need to replace the ink cartridge frequently, and the refilling process can be finished without pollution to the surrounding environment.

Another objective of the invention is to provide a bulk-capacity continuous feed printer ink container pack, having an interlocking structure with a raised block and a depressed slot on opposite sectional surfaces, that means each ink container is also an unitary section that can be assembled in a row with two or more ink containers to form an expandable high-capacity ink container pack, so that the ink containers in the ink container pack can be added or taken out flexibly to suit the requirements of the printer user.

A further objective of the invention is to provide a bulk-capacity continuous feed printer ink set that allows the printer users to replace and refill the ink containers with simple procedures.

To accomplish the above objectives, the bulk-capacity continuous feed printer ink container pack, in accordance with the present invention, employs corresponding number of ink containers and ink supply lines. Each ink supply line has one end connected to the refill hole of an ink container and another end to a refillable ink cartridge installed on a printer. The structure of the ink container includes an refill and an output hole, both on a top surface, where the output hole is connected to the ink supply line, and the refill hole is normally used for pressure balancing other than ink refilling; a raised block being formed on one sectional surface of the ink container with a trapezoidal shape; and a depressed slot on another sectional surface of the ink container, where the raised block and the depressed slot on opposite sectional surfaces are to lock against each other when two ink containers are attached to each other to form an ink container pack with double capacity. The shape of the ink container pack can be an rectangular block shaped or other parallelogram shapes to suit the user's needs as long as the high-capacity continuous feed ink container pack can provide a continuous supply of printer ink according to the specifications.

Also, to avoid accidental tumbling over of the ink containers when the ink supply lines are pulled or when the printer is moved, there is a line clipper on each ink supply line. When the printer needs to be moved to another location, the clipper on each ink supply line is first tightened, and one end of the ink supply line connected to the printer end is disconnected. The clipper is also be used in the ink refilling process to prevent staining of the user's hands and clothes and pollution to the surrounding environment.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 is a conventional bottle feed printer ink system installed on a printer;

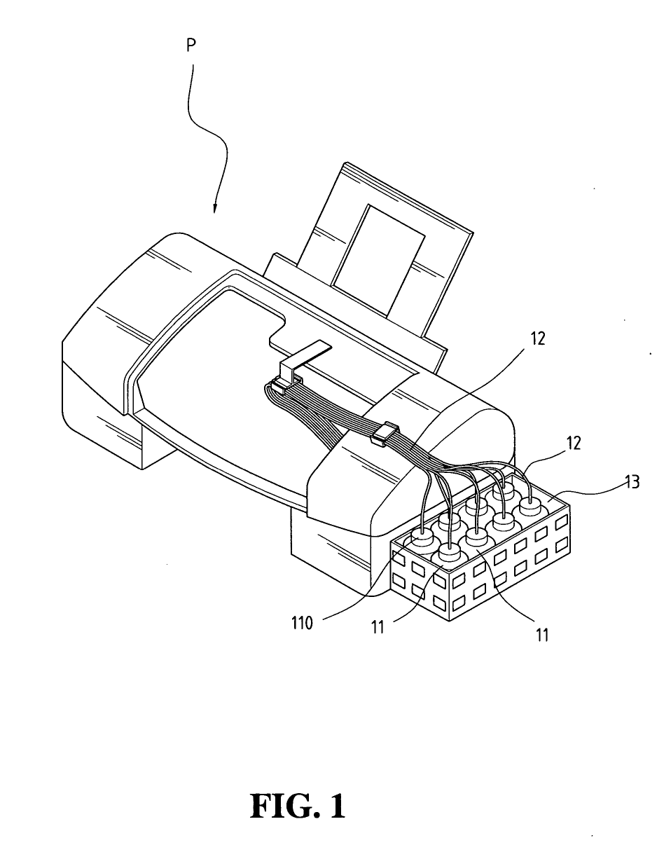

FIG. 2 is a perspective view of an ink container of a bulk-capacity continuous feed printer ink container pack in accordance with the present invention;

FIG. 3 is a cross-sectional view of the ink container of the bulk-capacity continuous feed printer ink container pack taken along line A-A of FIG. 2;

FIG. 4 shows a plurality of ink containers of the present invention to be assembled to form a bulk-capacity continuous feed printer ink container pack in accordance with the present invention;

FIG. 5 is an assembled bulk-capacity continuous feed printer ink container pack of the present invention;

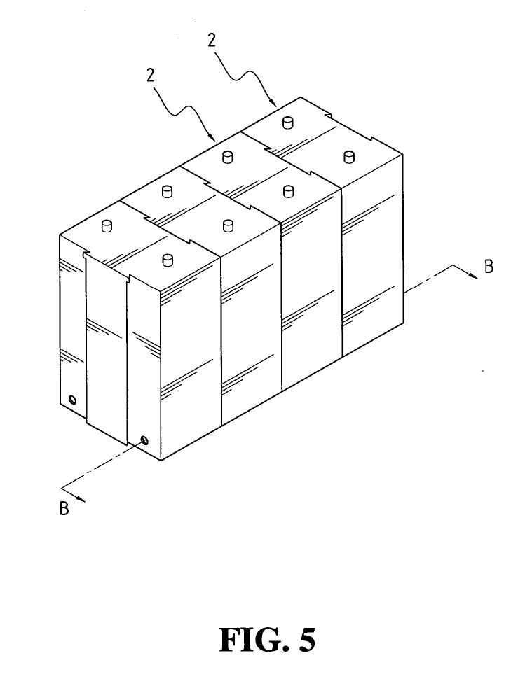

FIG. 6 is a cross-sectional view of the assembled bulk-capacity continuous feed printer ink container pack taken along line B-B of FIG. 5; and

FIG. 7 is a perspective view showing the bulk-capacity continuous feed printer ink container pack of the present invention installed on a printer.

### DETAILED DESCRIPTION OF THE PREFERRED EMBODIMENT

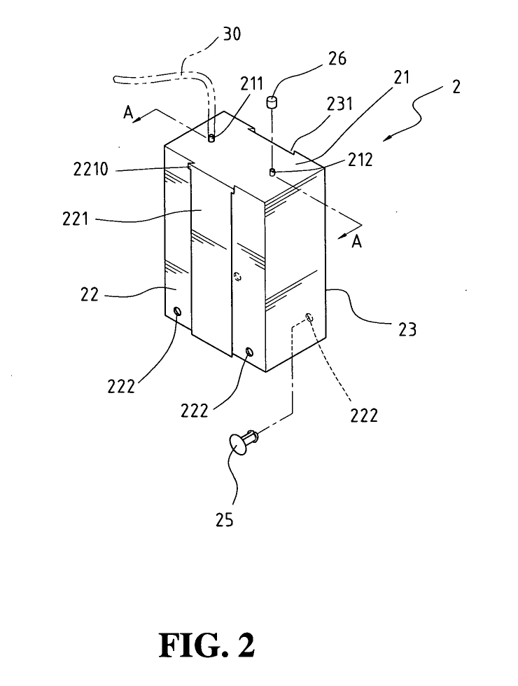

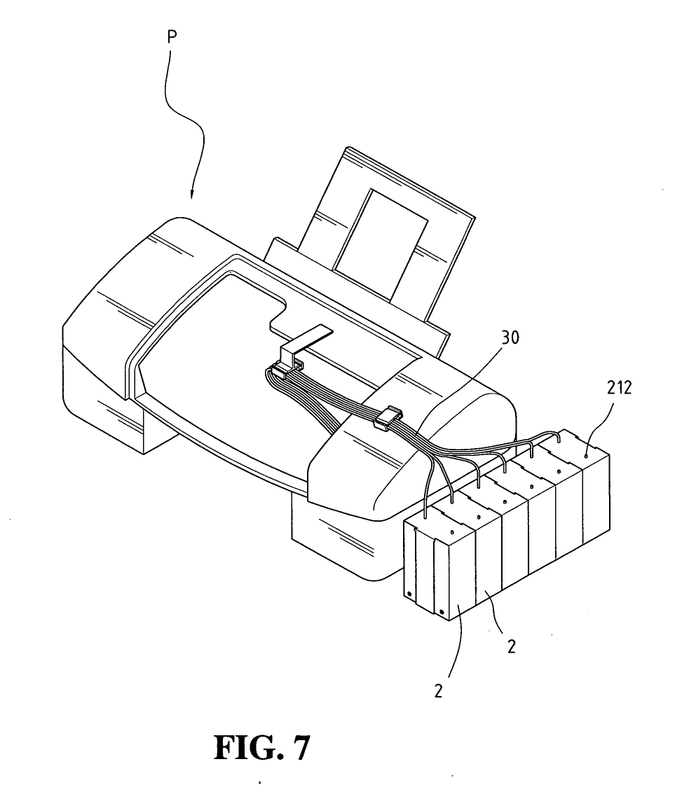

Referring to the drawings and in particular to FIG. 2, a bulk-capacity ink container 2 in accordance with the present invention is shown, which ink container 2 can be assembled with other ink containers 2 of the same type to form an expandable, bulk-capacity continuous feed printer ink container pack as shown in FIG. 7. The bulk-capacity ink container 2 comprises a refill hole 212, an output hole 211, a raised block 221, and a depressed slot 231. The raised block 221 and the depressed slots 231 on opposite sectional surfaces are to lock against each other when two or more ink containers of this type are assembled in a row to form an expandable continuous feed printer ink set.

The refill hole 212 and the output hole 211 are both formed on the top surface of the bulk-capacity ink container 2, where the output hole 212 is connected by an ink supply line 30 to the refillable ink cartridge of the printer as shown in FIG. 7, and the refill hole 212 is normally used for pressure balancing other than ink refilling. The other end of the ink supply line 30 connected to the refillable ink cartridge is not shown in drawings.

The raised block 221 having a trapezoidal shape is formed on the sectional surface 22 in the vertical orientation, and the depressed slot 231 is formed on the opposite sectional surface 23 also in the vertical orientation, corresponding to the position and shape of the raised block 221 on the other sectional surface 22. The raised block 221 of one ink container 2 is to lock against the depressed slot 231 of another ink container 2 when two ink containers of this type are attached to each other to form an expandable printer ink container pack with double capacity.

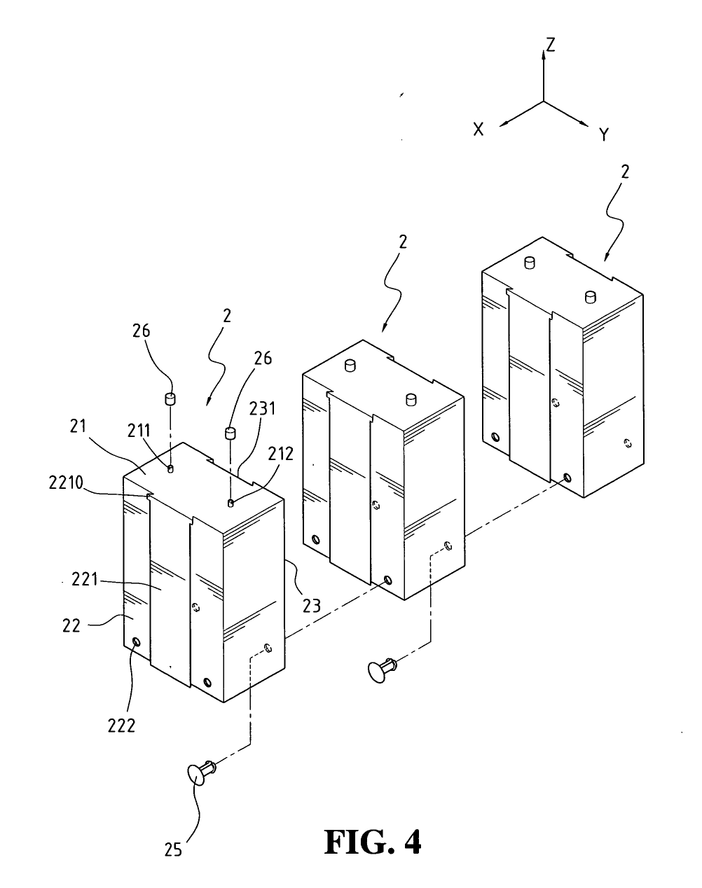

Referring to FIG. 4, each ink container 2 having a rectangular block shape has a raised block 221 on one sectional surface 22 in the vertical orientation, and the depressed slot 231 on another sectional surface 23 also in the vertical orientation, parallel to the raised block 221 on the opposite sectional surface 23. When two or more ink containers 2 are assembled, the raised block 221 of one ink container 2 is fitted into the depressed slot 231 of another ink container 2 along Z axis.

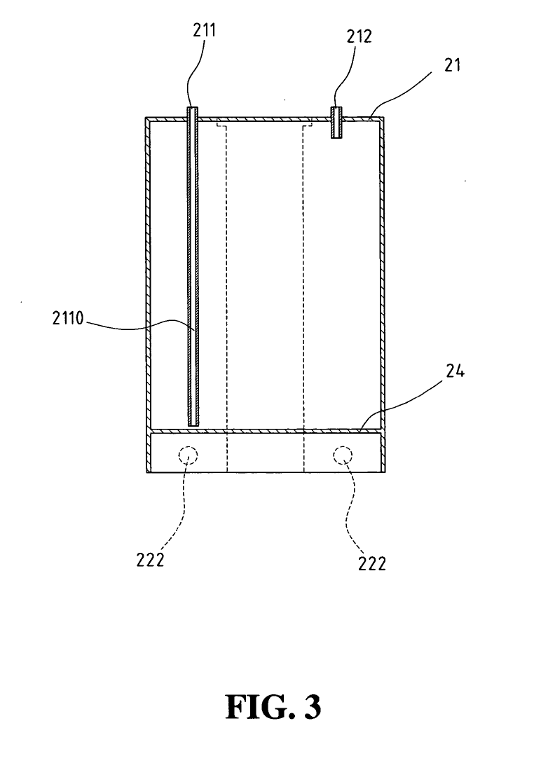

Preferably, the raised block 221 of the ink container has a T-shape extrusion 2210 in the transversal orientation, as shown in FIGS. 2 and 3, and the depressed slot 231 has an invert-T shaped channel, such that the raised block 221 of one ink container 2 and the depressed slot 231 of another ink container can be securely attached along Z axis to form an expandable printer ink container pack, thus fixing the two ink containers 2 against any movement along X and Y axes.

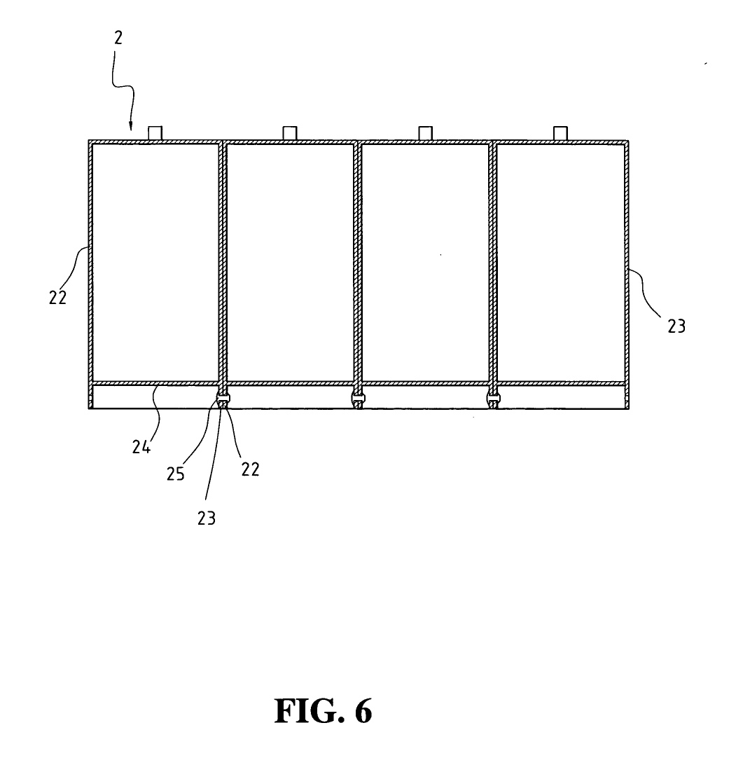

In a preferred embodiment, referring to FIGS. 3 and 6, the bottom surface 24 of the ink container 2 is slightly higher than the bottom edge of the sectional surfaces 22, 23, and each sectional surface 22, 23 has two coupling holes 222 toward the bottom located below the bottom surface 24 of the ink container 2.

Referring to FIGS. 3 and 6, the ink container has two couplers 25, each of which is inserted through the coupling hole 222, penetrating the walls of two adjacent ink containers 2 to have the two ink containers 2 securely attached, so that the assembled ink containers will be firmly fixed against any movement along Z axis, as well as along X and Y axes.

Referring to FIG. 3, to accomplish continuous feeding of printer ink to a printer, one end of a siphon 2110 is connected to the output hole 211 of the ink container 2, extending downward to the bottom surface 24. One end of the ink supply line 30 is connected to the output hole 211 of the ink container 2 as shown in FIG. 7, and another end is connected to the ink cartridge (not shown in diagram) of the printer P. The ink container 2 is preferably transparent or semi-transparent, such that the printer user is able to see the ink level through the walls of the ink cartridge and take appropriate action when the level of ink in the ink container 2 drops to a warning level or almost depleted. The user once detecting the abnormal situation can start to refill the ink container with new ink, or replace with another ink container that is full. The refill hole 212 and the output hole 211 can be covered by a cap 26 over the mouth to prevent spilling over of the ink container 2 when the ink inside the container is agitated.

The bulk-capacity ink container pack of the continuous feed printer ink system in accordance with the present invention is able to provide continuous supply of printer ink without interruption of the printer service. The innovative structure of the ink container allows the user to replace the ink container easily no messing up of the user's clothes and other documents over the desk top. Furthermore, the ink container is also an unitary section that can be assembled together with two or more ink containers to form an expandable printer ink container pack, so that the number of container sections in a printer ink container pack can be added or taken out as needed depending on the printer user, thus costs of maintaining the printer ink supply can be considerably decreased.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A bulk-capacity continuous feed printer ink container pack, comprising multiple bulk-capacity ink containers, each being connected by an ink supply line, where one end of which is connected to the ink container, and the other end is connected to a refillable ink cartridge of a printer, wherein the structure of the bulk-capacity ink container includes:
a refill hole and an output hole, both formed on the top surface of the ink container, wherein the output hole is connected by the ink supply line, and the refill hole is normally used for pressure balancing other than ink refilling;
a raised block with a trapezoidal shape being formed on a sectional surface in the vertical orientation;
a depressed slot being formed on another sectional surface, opposite to the sectional surface of the raised block, corresponding to the position of the raised block and in parallel with the raised block;
wherein the raised block and the depressed slot are to lock against each other when two adjacent ink containers of the same type are attached to each other to form an expandable ink container pack with double capacity.

2. The continuous feed printer ink system as claimed in claim 1, wherein the raised block has a T-shaped trapezoidal shape, and the depressed slot has an invert-T channel.

3. The continuous feed printer ink system as claimed in claim 1, wherein the ink container has a bottom surface slightly higher than the bottom edge of the sectional surface, and each sectional surface, including the surfaces with the raised block and the depressed slot, has two coupling holes near the bottom, being located below the bottom surface of the ink container.

4. The continuous feed printer ink system as claimed in 3, wherein the ink container also has two couplers to be inserted through the two coupling holes, penetrating the walls of two adjacent ink containers, such that two adjacent ink containers of the same type can be attached to each other to form an expandable printer ink container pack with double capacity.

5. The continuous feed printer ink system as claimed in claim 1, wherein the ink container also has a siphon connected from the inside of the output hole extending down to reach the bottom surface of the ink container.

6. The continuous feed printer ink system as claimed in claim 1, wherein the ink container also has a cap to be placed over the refill hole and the output hole.

7. The continuous feed printer ink system as claimed in claim 5, wherein the ink container also has a cap to be placed over the refill hole and the output hole.
